(19) United States
(12) Patent Application Publication
(10) Pub. No.: US 2019/0003797 A1
(43) Pub. Date: Jan. 3, 2019

(54) GUN BARREL CLEANING DEVICE

(71) Applicant: Claire C. Marvin, New Albany, OH (US)

(72) Inventor: Claire C. Marvin, New Albany, OH (US)

(21) Appl. No.: 15/895,481

(22) Filed: Feb. 13, 2018

Related U.S. Application Data
(60) Provisional application No. 62/526,689, filed on Jun. 29, 2017.
(60) Provisional application No. 62/538,492, filed on Jul. 28, 2017.

(51) Int. Cl. F41A 29/02; B08B 1/00; B08B 9/043

(52) U.S. Cl. CPC F41A 29/02; F41A 29/04; B08B 9/0436; B08B 1/006

(57) ABSTRACT

A system for cleaning debris from a tubular barrel assembly is disclosed. A cleaning device includes a member having an enlarged section located on a distal end thereof. The enlarged section has an outer surface that extends beyond the outer surface of the member. A shaft section extends from a distal end of the enlarged section. A securing member includes an aperture which is configured to accommodate the shaft section and a first and second protuberance that extend from the same. The securing member also includes a slotted section that selectively engages the first and second protuberances when rotated.

### CROSS-REFERENCE TO RELATED APPLICATION

This application claims the benefit of U.S. Provisional Patent Application Ser. No. 62/526,689 filed Jun. 29, 2017 and U.S. Provisional Patent Application Ser. No. 62/538,492 filed Jul. 28, 2017, the disclosures of all of which are hereby incorporated by reference in their entities.

### TECHNICAL FIELD

Exemplary embodiments of the present invention relate generally to a device for cleaning a gun barrel and a method of use for such a device.

### BACKGROUND AND SUMMARY OF THE INVENTION

Firearms generally comprise a barrel structure, a chamber for housing a propellant, and a method of causing the propellant to propel a projectile down the barrel structure. The barrel structure is intended to guide the projectile toward its intended target. Frequently, the inner surface of the barrel structure may be caused to have spiral indentations intended to cause the projectile to spin as it travels down the barrel. Such spin imparts stability and may result in a projectile that more consistently travels the path imparted by the barrel assembly. Other embodiments of firearms may have smooth inner barrel structure surfaces. Such other embodiments may rely on other methods of guiding a projectile towards its intended target. In order to guide a projectile towards its intended target, the inner surface of the barrel structure may have an inner diameter that is very close to the outer diameter of the projectile. This closeness in diameter is particularly critical when the barrel is designed to impart a spinning motion on the projectile.

Projectiles are frequently comprised of lead or other malleable material. In addition, some projectiles may have a coating or jacket material such as copper. As these projectiles travel down the barrel, the closeness in diameter causes the projectile to rub against the barrel assembly inner surface. The result may be traces of lead, copper, or other materials deposited from the projectile onto the barrel assembly.

Many embodiments of firearms rely on a propellant such as gunpowder or a similar chemical composition to propel a projectile down the barrel assembly. These designs may use a pressure sensitive substance to ignite the gunpowder in response to a user action such as pulling a trigger device. When the gunpowder ignites, it causes an explosion within a portion of the barrel assembly resulting in a rapidly expanding gas. This gas causes the projectile to travel rapidly down the barrel assembly and then continue on to the intended target. As the result of the exploding gunpowder, chemical particles may be deposited onto the inner surface of the barrel assembly.

As described above, traces of lead, copper, and other materials as well as chemical particles that result from the explosion of propellant may be deposited on the barrel assembly inner surface. Over time, such deposits may damage the surface of the gun barrel assembly and can interfere with the interface between the projectile and the gun barrel. Such interference may result in a reduction of the accuracy and performance of the firearm. As a result, the inner surface of the barrel assembly should be regularly cleaned to remove deposits.

Cleaning devices such as rods or cable devices are known in the art. Such devices commonly have removable cleaning devices. During an exemplary process for cleaning a barrel assembly these devices may be removed and replaced with devices for performing the various steps in the cleaning process. For example, a device for holding a cloth saturated with a cleaning solution may be caused to be attached to a cleaning rod. This cloth may then be pushed or pulled through the barrel assembly to cause cleaning solution to be deposited therein. The device for holding a cloth may be removed from the cleaning rod and replaced with a brush or scraper device to remove deposits from the barrel assembly. In this exemplary cleaning process, the brush or scraper may be removed and replaced with another device for holding a cloth that contains a corrosion inhibitor or lubricant material. As with the cleaning solution saturated cloth, this cloth containing a corrosion inhibitor or lubricant material may be pushed or pulled through the barrel assembly to deposit the corrosion inhibitor or lubricant onto the barrel assembly inner surface.

As described above, it is common for a cleaning process to be performed using multiple steps where each step may require a different device. A frequent problem during the performance of such steps is the recurring need to remove and replace the various devices used during the cleaning process. Known designs of cleaning devices, cleaning rods, and cleaning cables use a threaded interface between the rod or cable and the cleaning devices. Such a threaded interface requires that the user twist the cleaning device to engage the threaded interface and continue to twist until the threaded cleaning device is fully secured to the rod or cable. In order to accommodate longer gun barrel assemblies, sections of rod or cable are frequently required to be threaded together in a manner similar to what was described for attaching the cleaning device. In addition to being time consuming and tedious to assemble, threaded assemblies may be susceptible to cross-threading which may damage or destroy the threaded connection. Such a damaged connection may separate during use, resulting in a cleaning device becoming lodged in the barrel assembly or barrel damage from the unsecured cleaning rod or cable. Such a threaded assembly may also become unscrewed, even if the threaded section is not damaged. Again, this could result in the cleaning device becoming lodged in the barrel assembly. A known improvement to such a threaded connection is a connection that uses an enlarged end located on the cleaning device which is inserted into a keyhole shaped receiver located on a cleaning rod or cable. While such a connection eliminates the need to thread a cleaning device onto a barrel cleaning rod or cable, it only serves to secure the connection during a pulling motion. A pushing motion may cause this connection to release or become misaligned. The ability to push and pull a cleaning device through a gun barrel assembly allows for a more effective cleaning operation and eliminates the need to pull a cleaning device through the gun barrel assembly, disconnect the device from the cleaning rod or cable, reinsert the cleaning rod or cable, and reattach the cleaning device in order to perform the cleaning step a second time. With an attachment method that allows a user to apply a pushing and pulling motion to a cleaning device, that user may “scrub” the cleaning device back and forth in areas of the gun barrel assembly that require additional cleaning.

A common cleaning device includes an oval shaped head configured to accommodate a typically folded cloth used for cleaning the gun barrel. However, the cloth is susceptible to being shifted, moved, or dislodged during the cleaning process. This can result in the cloth being left in the barrel, which requires additional time and effort to remove. Further, frequent adjustment to the cloth may be required. What is needed is a barrel cleaning tool having a cleaning device which securely holds a cloth.

The present invention is a barrel cleaning tool which securely holds a cloth. The barrel cleaning tool may comprise a cleaning device which has a member, a shaft portion, and an enlarged section. The cleaning device may further comprise a securing member. The securing member may comprise an aperture, which in exemplary embodiments, is sized such that the securing member may be placed over and be slidably mounted to the shaft portion and the member. The enlarged section may be sized to prevent the securing member from passing therebeyond. In this way, when the member is secured to the cleaning rod portion, the securing member may be squeezed, press fit, or otherwise sandwiched between the distal end of the cleaning rod portion and the proximal end of the enlarged section. A cloth may be placed between the shaft portion and the enlarged section and the securing member such that it is sandwiched between the proximal end of the enlarged section and the distal end of the securing member. In this way, the cloth may be held in position when the cleaning device is passed through the gun barrel.

In other exemplary embodiments, the enlarged section may further comprise a notched or threaded section extending from an end thereof. The notched or threaded section may allow a cloth to be secured thereto. Alternatively, or in addition, the securing member may be configured to be secured to the notched or threaded section, thus securing the cloth between the proximal end of the enlarged section and the distal end of the securing member. In such embodiments, the shaft section may not be required.

In still other exemplary embodiments, the barrel cleaning tool may comprise a member, which may have an engagement groove located on or near a first end thereof. An enlarged section may extend from a second end of the member. The enlarged section may be substantially cylindrical in shape and comprise a ribbed outer surface. A shaft may extend from the distal end of the enlarged section. The shaft may have a substantially circular cross section and may further comprise a first and second protuberance extending therefrom.

A securing member may be configured to be slidably mounted to said shaft. The securing member may comprise an aperture configured to accommodate the shaft and the protuberances. The securing member may further comprise a first and second slot configured to accommodate the first and second protuberances, respectively, when the securing member is rotated. The protuberances and the slots may be respectively located such that a gap remains between the proximal end of the securing member and the distal end of the enlarged section when the securing section is mounted to the shaft. The gap may be sized and configured to accommodate a cloth.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view illustration of an embodiment of the invention applied to a cleaning rod and cleaning device interface;

FIG. 2 is a cutaway view of an embodiment of the invention showing the cleaning rod and cleaning device interface partially engaged;

FIG. 3 is a cutaway view of an embodiment of the invention showing the cleaning rod and cleaning device interface fully engaged;

FIG. 4 is a cutaway view of an embodiment of the invention comprising an adapter for a threaded cleaning rod adapter illustrating a cleaning device fully engaged with an embodiment of the cleaning device interface;

FIGS. 5A-5C illustrate a cross section view of an embodiment of the invention showing the cleaning device to hinged latch connection;

FIGS. 6A-6C are illustrations of a tapered axial recess for receiving the cleaning device in embodiments of the invention;

FIGS. 7A-7B illustrate a tapered hinged latch used in certain embodiments of the invention;

FIG. 8 illustrates a raised portion of a hinged latch used in certain embodiments of the invention to allow a user to more easily depress the hinged latch to release the cleaning device from the cleaning rod;

FIG. 9 illustrates a perspective view of another exemplary embodiment of the cleaning device;

FIG. 10 illustrates a side view of an exemplary securing member for use with the cleaning device of FIG. 9;

FIG. 11 is a front view of the securing member of FIG. 10;

FIG. 12 is a side view of the cleaning device of FIG. 9;

FIG. 13 is a side view similar to FIG. 12 with the securing member removed for clarity;

FIG. 14 is a side view of another embodiment of the cleaning device;

FIG. 15 is a side view of another embodiment of the cleaning device;

FIG. 16 is a front view of an exemplary cloth;

FIG. 17 is a perspective similar to FIG. 9 with the cloth of FIG. 16 secured thereto;

FIG. 18 is a side view similar to FIG. 14 with the cloth of FIG. 16 secured thereto;

FIG. 19 is a side view illustrating an exemplary use of the cleaning tool;

FIG. 20 is a side view of another embodiment of the cleaning device;

FIG. 21 is a front view of the device of FIG. 20;

FIG. 22 is a side view of another exemplary securing member for use with the cleaning device of FIG. 20;

FIG. 23 is a front view of the securing member of FIG. 22;

FIG. 24 is a side view the device of FIG. 20 with the securing member of FIG. 22 installed thereon in an unlocked position;

FIG. 25 is a front view of the device of FIG. 24;

FIG. 26 is a side view of the device of FIG. 24 with the securing member of FIG. 22 installed thereon in a locked position; and

FIG. 27 is a front view of the device of FIG. 26.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

The present invention comprises an improved device for cleaning tubular barrel assemblies, including gun barrels. One skilled in the art will realize that such an invention may be used to clean other elongated tubular structures such as, but not limited to, pipes, musical instruments, chimneys, and laboratory instruments. A preferred embodiment of the present invention may utilize a molded plastic material as described herein but one ordinarily skilled in the art will understand that an equivalent device may be fabricated from other materials including, but not limited to, metals, wood, and glass without departing from the spirit of the invention.

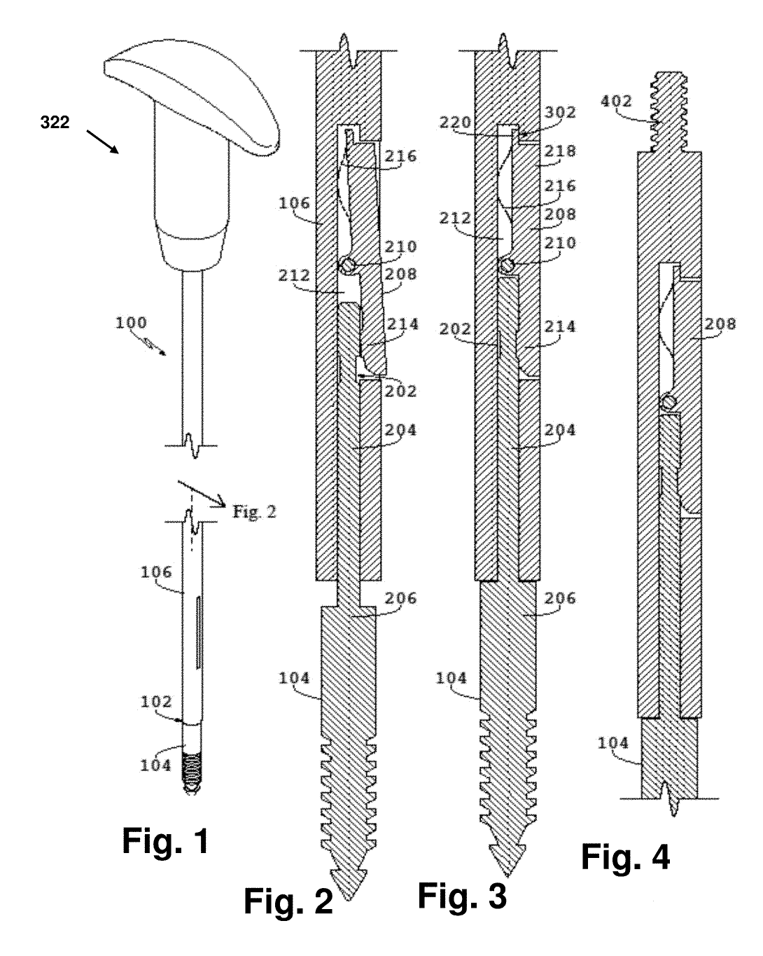

FIG. 1 illustrates, in a perspective view, a barrel cleaning tool 100 configured with an embodiment of the invention. As is illustrated at 102, a barrel cleaning device 104 is secured to a cleaning rod portion 106 of the cleaning tool 100. This cleaning rod portion 106 may be fabricated from a rigid material but may also be fabricated from a flexible material. Examples of such a flexible material may be, but are not limited to, flexible plastic or a cable material. FIG. 2 illustrates a cutaway view of a portion of the barrel cleaning device 104 showing an engagement groove 202, a member 204, and an enlarged section 206. As illustrated, the barrel cleaning device 104 is partially inserted into an axial recess 212 of the cleaning rod portion 106 of the barrel cleaning tool 100. A hinged latch 208 located in a recess formed in the cleaning rod portion 106 of the cleaning tool 100 is illustrated in a partially raised position. The hinged latch 208 may be affixed to the cleaning rod 106 using a pivot pin 210 or similar shape. As is illustrated in the figure, as the barrel cleaning device 104 is being inserted into an axial recess portion 212 of the cleaning rod 106, the leading edge of the hinged latch 214 may rest against the member 204 of the barrel cleaning device 104. As is shown, a spring 216 may be used to cause the leading edge of the hinged latch 214 to be pressed against the member 204 of the barrel cleaning device 104. Although the spring 216 is illustrated as a ribbon shape, such a spring may also be a coil shape or a flexible material anchored such as to apply pressure against the hinged latch 208. In addition to or in place of the springs described, embodiments of the invention may employ material such as, but not limited to, rubber, latex, or other compressible material to apply pressure to the hinged latch 208.

As illustrated in FIG. 3, as the member 204 of the barrel cleaning device 104 is fully inserted into a hollow shaft portion 212 of the shaft 106 of the cleaning tool 100, the enlarged section 206 of the barrel cleaning device 104 may come into contact with the end of the cleaning rod 106. At about the same time, the leading edge of the hinged latch 214 may be pressed into the engagement groove 202 formed in the member 204 of the cleaning device 104 by the spring 216. As a result, the cleaning device 104 may become firmly affixed to the end of the shaft 106 of the barrel cleaning tool 100. To remove the cleaning device 104 from the end of the shaft 106, a user may apply pressure to the trailing end 218 of the hinged latch 208. Such pressure may compress the spring 216 and cause the hinged latch 208 to pivot about the pivot pin 210 which in turn, causes the leading edge 214 of the hinged latch 208 to lift out of the engagement groove 202, releasing the cleaning device 104 from the barrel cleaning tool 100.

In order to keep the hinged latch 208 from protruding beyond the outer diameter of the cleaning rod 106, a narrow ledge 220 may be formed in the trailing edge of the pivot latch 208. This narrow latch may be positioned such that it comes to rest against an inner surface of the hollow shaft portion 212 such that it prevents the trailing edge of the pivot latch 208 from being forced beyond the outer surface of the cleaning rod 106 by the spring 216. This is illustrated in FIG. 3 at 302.

A plurality of different cleaning devices may be connected to a cleaning rod 106 or cable using the engagement ridge and engagement latch arrangement described above. The cleaning device 104 shown is exemplary and it is not intended to represent the only such device that may be used in embodiments of the invention. Many other types of cleaning devices may be used, examples of which may include, but are not limited to, cleaning cloth loops, brushes, scrapers, and swabs. Additional embodiments of the invention may comprise a cleaning device interface that includes a member 204, an enlarged section 206, and an engagement groove 202 and that also comprises a threaded opening to allow for the attachment of threaded cleaning devices such that the convenience afforded to a user of the invention may be extended to other types of cleaning devices.

In addition to the embodiments described above and illustrated in FIGS. 1, 2 and 3, an embodiment of the invention may also be comprised of an adapter design intended to be affixed to gun barrel cleaning tools which are configured with less convenient cleaning device attachment methods, an example of which may be a threaded connection. Other attachment methods may include, but are not limited to, press-fit, crimping, and adhesive. Such an adapter may comprise a first end with an attachment interface portion and a second end with a recess and pivot latch as described previously. An example of such an embodiment is illustrated in FIG. 4. As is shown, a threaded portion 402 may be provided to attach the adapter to a threaded gun cleaning rod. Other embodiments may replace the threaded portion with an appropriate shape depending upon the attachment method employed. Once attached, a user may change cleaning devices 104 by pressing the pivot latch 208 and removing or installing the cleaning device 104 as described earlier.

To conduct a gun barrel cleaning operation, a user may perform the described twisting motion to attach and remove cleaning devices without having to repeatedly twist to attach and detach cleaning devices as is the case when using known threaded attachment methods. In addition to attachment of cleaning devices, the invention may be applied to connect additional sections of barrel cleaning rods to accommodate longer barrels.

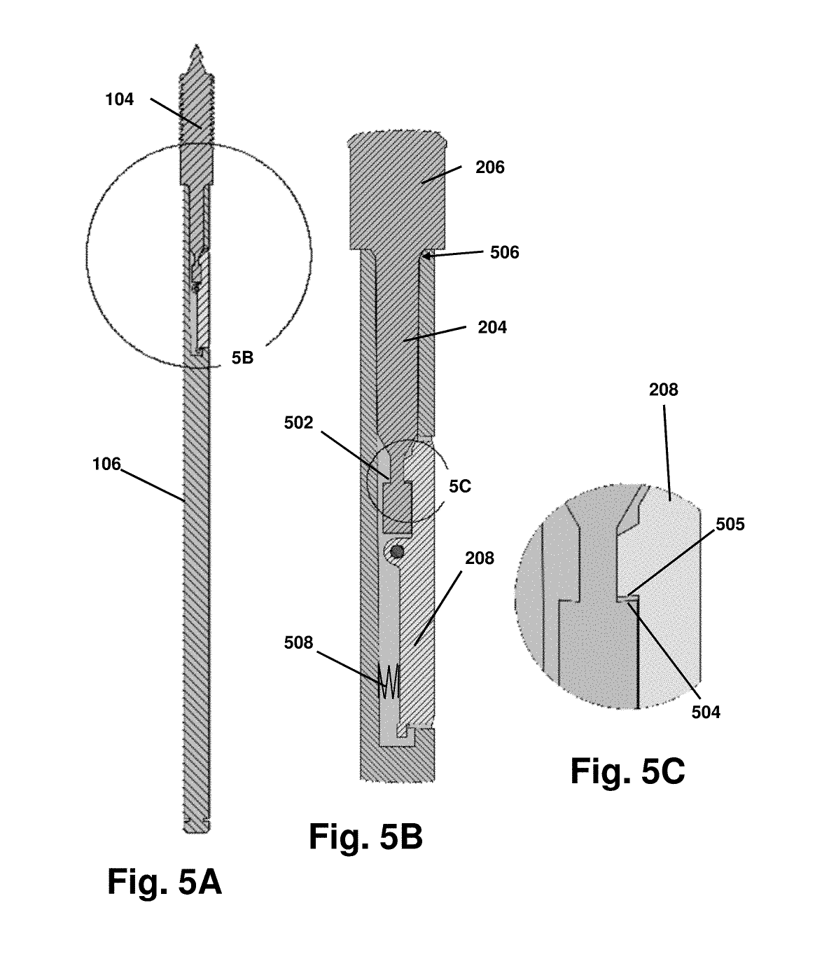

In addition to the features described above, embodiments of the present invention may be formed from a fiber reinforced plastic material. Such materials may result in a cleaning device that is less likely to damage a gun barrel, may be less susceptible to rust or corrosion, and may be less costly to produce as the result of efficient molding processes. Referring to FIG. 5A, a barrel cleaning device 104 is illustrated affixed to a cleaning rod portion 106. As was noted above, a hinged latch 208 may be positioned to engage an engagement groove 502. Referring to FIG. 5C, which illustrates the hinged latch 208 in the engagement groove 502, an inward or back bevel 504 may be formed at the point where the engagement groove 502 is in contact with the hinged latch 208. As is illustrated, in a preferred embodiment, a corresponding bevel 505 may be formed in the hinged latch 208 in order to more fully secure the cleaning device 104. Such a bevel arrangement may result in the hinged latch 208 being drawn more tightly against the engagement groove 502 as a pulling force is exerted against the cleaning device. As will be described in more detain herein, the member 204 of the cleaning device 104 may be formed so as to be rectangular in cross section. In such a configuration, the engagement groove may be formed in two opposite sides of the cleaning tool. Because of the inward bevel shape, this arrangement of two opposing engagement grooves will permit the cleaning device to be removable from a mold without requiring an unduly complex mold. In certain embodiments the rectangular shape of the first shaft portion may have equal or nearly equal sides (forming a square) while in other embodiments, the rectangular shape may have two sides that are shorter. In such an embodiment, the cleaning device will only fit into the rod in two orientations while an embodiment that is square will fit in four orientations.

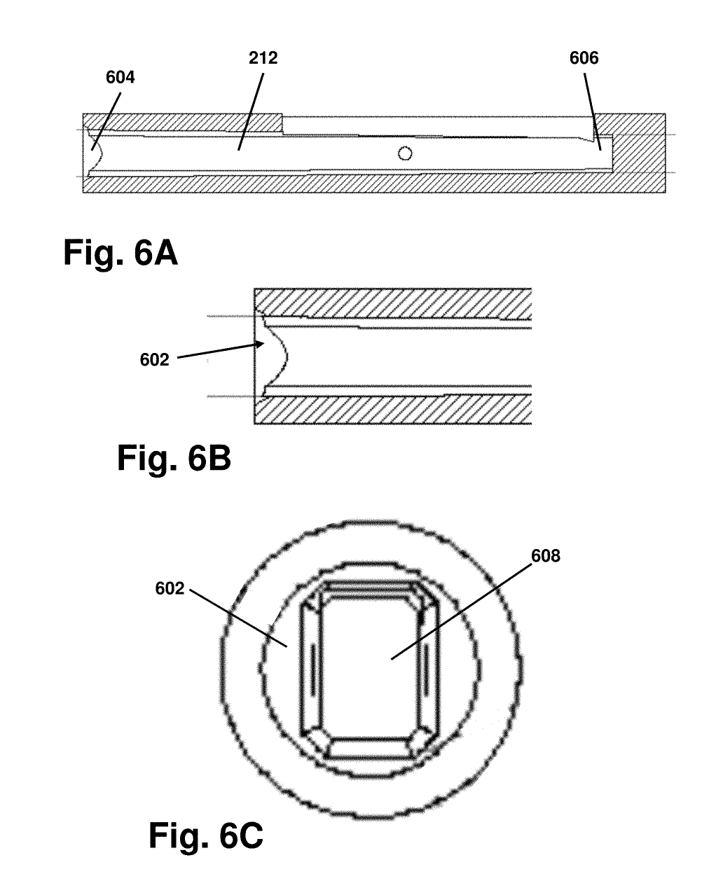

In order to increase the strength of a potential failure point at the junction of the member 204 and enlarged section 206, an arcuate shape may be formed at the transition of these two portions. An example of such a shape is illustrated at 506 of FIG. 5B. In order to allow the cleaning device to properly connect to the cleaning rod 106, the axial recess opening of the rod into which the member 204 of the cleaning device is inserted may be formed with a corresponding arcuate shape. This shape is illustrated in FIGS. 6B and 6C at 602. Such a corresponding shape 602 permits the second shaft of the cleaning device 104 to rest firmly against the end of the cleaning rod 106.

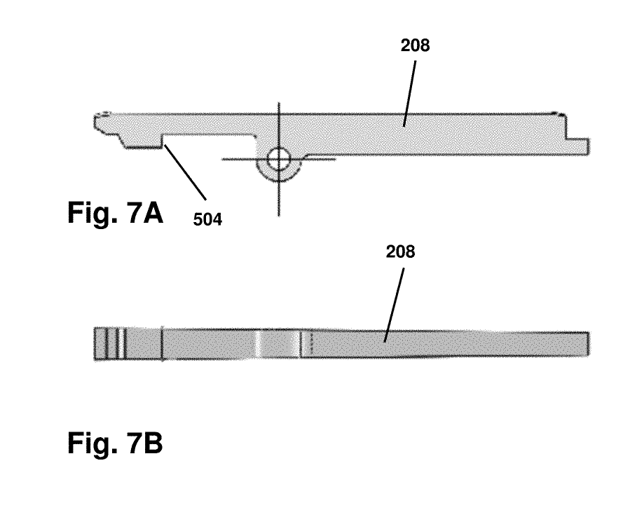

As was noted above, the member 204 of the cleaning device 104 may be rectangular in cross section. This rectangular shape performs two functions, the first is to prevent the cleaning device from rotating in relation to the cleaning rod and second, the rectangular shape serves to orient the shaft such that one of the two engagement grooves (which are located on opposite sides of the cleaning device 104) aligns with the hinged latch 208 to secure the cleaning device. The member 204 may comprise a substantially rectangular cross section, though any cross section is contemplated, and may be tapered from the point at which the first shaft connects to the second shaft portion of the cleaning device 104 to the end of the shaft. This taper serves to more securely connect the cleaning device into the axial recess 212 of the cleaning tool 100. A cross section of the axial recess 212 is illustrated in FIG. 6A. As can be observed, the opening end 604 of the axial recess 212 is slightly larger than the closed end 606. This results in a taper from the opening end to the closed end of the axial recess which mates with a corresponding taper found on the first shaft of the cleaning device 104. As is illustrated at 608 of FIG. 6C, this axial recess is also rectangular in cross section to mate with the rectangular member 204 of the cleaning device. As was discussed earlier herein, the hinged latch 208 is disposed in an opening formed in the cleaning rod 106 such that it makes contact with the cleaning device. An illustration of the hinged latch in position is shown in FIG. 5B. As was noted above, the axial recess tapers from an open end to a closed end. To permit the hinged latch to make contact with the cleaning device without contacting the walls of the recess in such a tapered axial recess, an embodiment of the hinged latch 208 may also be tapered. Also illustrated is a spring 508 which applies pressure to the hinged latch 208 to hold it in place against the rectangular member 204 of the cleaning device 104. FIG. 7A illustrates a side view of the hinged latch showing the inward bevel 504 described above. As may be observed in FIG. 7B, the hinged latch 208 is also tapered from the inward bevel end of the latch to the portion of the hinged latch that is positioned near the closed end of the axial recess. This taper of the hinged latch serves to prevent the hinged latch from binding with the tapered portion of the axial opening when the latch is depressed to release the cleaning device.

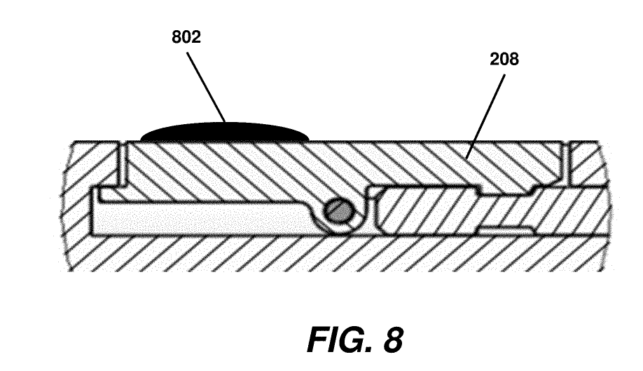

In addition to the tapered latch, a raised portion may be formed on an outer portion of the hinged latch as illustrated in FIG. 8 at 802. This raised portion permits a user to more easily depress the hinged latch 208 in order to release the cleaning device.

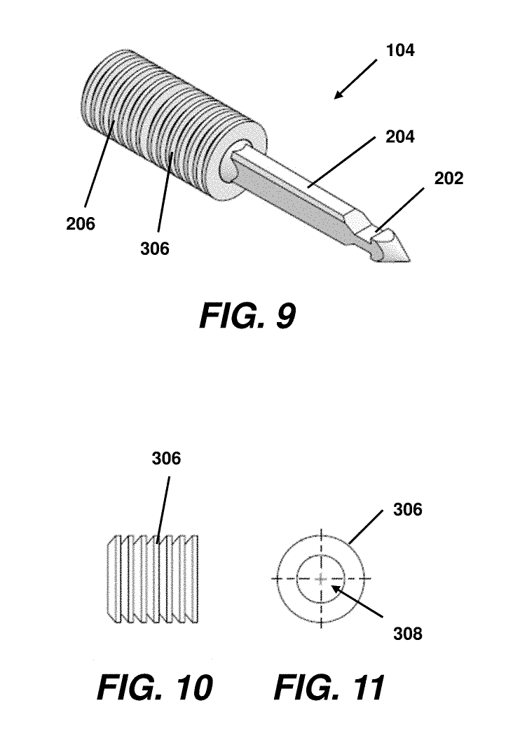

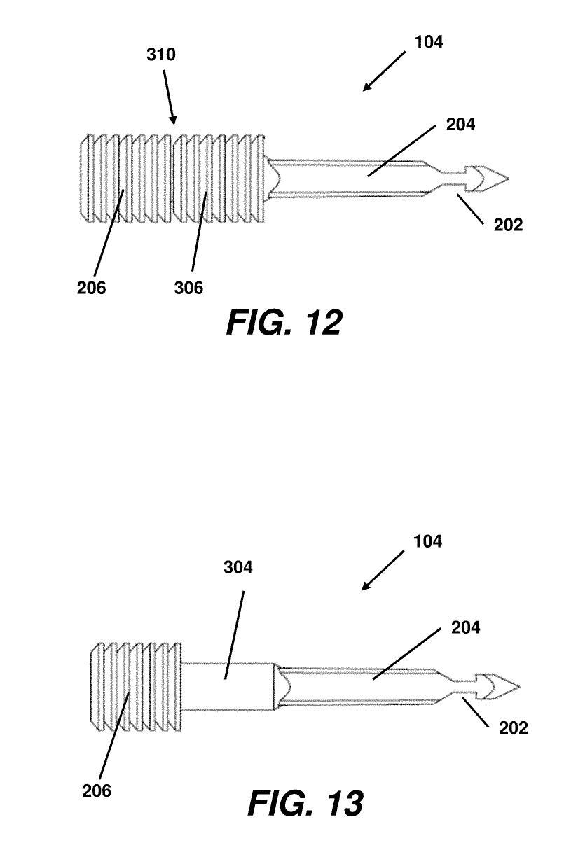

FIG. 9 through FIG. 13 illustrate another exemplary cleaning device 104. Similar to other embodiments presented herein, the cleaning device 104 may comprise the member 204 having the engagement groove 202 and the enlarged section 206. The cleaning device 104 may be configured to be selectively secured to the cleaning rod portion 106. In this way, the cleaning device 104 may be moved throughout the gun for cleaning, particularly in an axial direction through the gun barrel. The enlarged section 206 may be integrally formed with the member 204 or may be otherwise adhered or bonded thereto. In exemplary embodiments, the enlarged section 206 has a larger outer diameter than the member 204. The enlarged section 206 may be substantially circular in cross section, though any shape is contemplated. The enlarged section 206 may comprise a series of ridges, though such is not required. Alternatively, or in addition, the enlarged section 206 may be described as being substantially cylindrical in shape and comprising a ribbed outer surface. The outer diameter of the ridges may be substantially equal to the inner diameter of the gun barrel such that the ridges may aid in the cleaning process by removing deposit from the inner diameter of the barrel.

A shaft section 304 may extend between the member 204 and the enlarged section 206. In exemplary embodiments, the shaft section 304 is substantially circular in cross section, though any cross section is contemplated. In exemplary embodiments, the shaft section 304 has a larger cross section than the member 204, but a smaller cross section than the enlarged section 206.

The cleaning device 104 may further comprise a securing member 306 configured to be press fit or otherwise placed in close proximity to the enlarged section 206. In exemplary embodiments, the securing member 306 is shaped as a hollow cylinder such that an aperture 308 is formed in the center thereof. The aperture 308 may be sized such that the inner diameter of the securing member 306 is substantially the same as the outer diameter of the shaft section 304. In this way, the securing member 306 may be securely and slidably mounted to the shaft section 304. The securing member 306 may likewise comprise ridges or otherwise match the profile of the enlarged section 206, though such are not required.

The securing member 306, the shaft section 304, the enlarged section 206, or some combination thereof may be configured to prevent the securing member 306 from traveling beyond a certain location on the shaft section 304 such that a gap 310 is maintained between the securing member 304 and the enlarged section 206. The gap 310 may be sized to accommodate a cloth 316. In exemplary embodiments, the gap 310 may be 0.015 inches in size, though any size is contemplated.

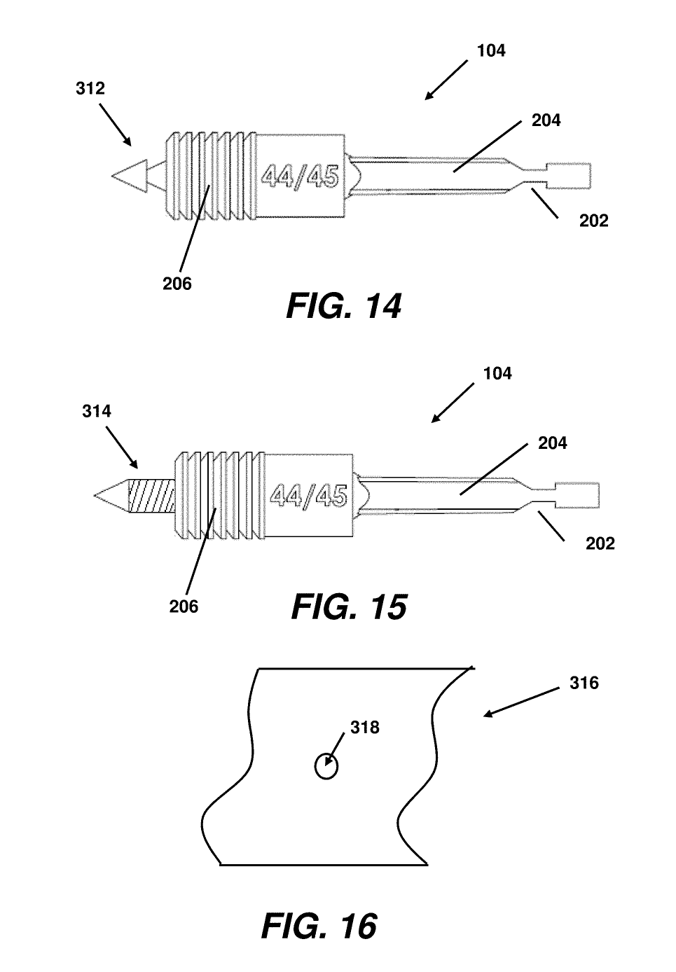

FIG. 14 illustrates another exemplary embodiment of the cleaning device 104. Similar to other embodiments presented herein, the cleaning device 104 may comprise the member 204 having the engagement groove 202 and the enlarged section 206 and the cleaning device 104 may be configured to be selectively secured to the cleaning rod portion 106. A notched section 312 may extend from the distal end of the enlarged section 206. In exemplary embodiments, the notched section 312 may comprise a tip which is conical in shape placed on the distal end of a truncated cone. In this way, a notched area is formed between the proximal end of the tip and distal end of the truncated cone. In other exemplary embodiments, the notched section 312 may comprise multiple notched areas. The multiple notched areas may be formed by stacking multiple truncated cones atop one another, though such is not required. Regardless, the notched section 312 may be configured to accommodate the cloth 316 such that the cloth is secured within the notched section 312.

In other exemplary embodiments, the securing member 306 may be configured to be secured to the notched section 312. For example, but not to serve as a limitation, the aperture 308 may be sized such that the securing member 306 may be wedged partially or wholly onto the notched section 312. In this way, the cloth 316 may be sandwiched between the securing member 306 and the enlarged section 206.

FIG. 15 illustrates another exemplary embodiment of the cleaning device 104. Similar to other embodiments presented herein, the cleaning device 104 may comprise the member 204 having the engagement groove 202 and the enlarged section 206 and the cleaning device 104 may be configured to be selectively secured to the cleaning rod portion 106. A threaded section 314 may extend from the distal end of the enlarged section 206. In this way, the cloth 316 may be placed on and secured to the threaded section 314.

In other exemplary embodiments, the securing member 306 may be configured to be threaded to the threaded section 314. For example, but not to serve as a limitation, the securing member 306 may comprise corresponding threads around the inner diameter of the aperture 308 that permit the securing member 306 to be threaded to the threaded section 314. In this way, the cloth 316 may be selectively sandwiched between the securing member 306 and the enlarged section 206.

FIG. 16 illustrates an exemplary cloth 316. The cloth 316 may be comprised of an absorbent material, though any material is contemplated. The cloth 316 may comprise a hole 318 which may be formed, stamped, punched, cut, torn, or otherwise created therein. In exemplary embodiments, the hole 318 may be located in substantially the center of the cloth 316 though any location is contemplated. The pre-formed hole 318 may aid in placing the cloth on the shaft section 304, the notched section 312, or the threaded section 314. In other exemplary embodiments, the hole 318 may not be pre-formed and instead may be formed by a user manually pressing the cloth 318 onto the shaft section 304, the notched section 312, or the threaded section 314. Any size or shape cloth 316 comprised of any one or more materials is contemplated.

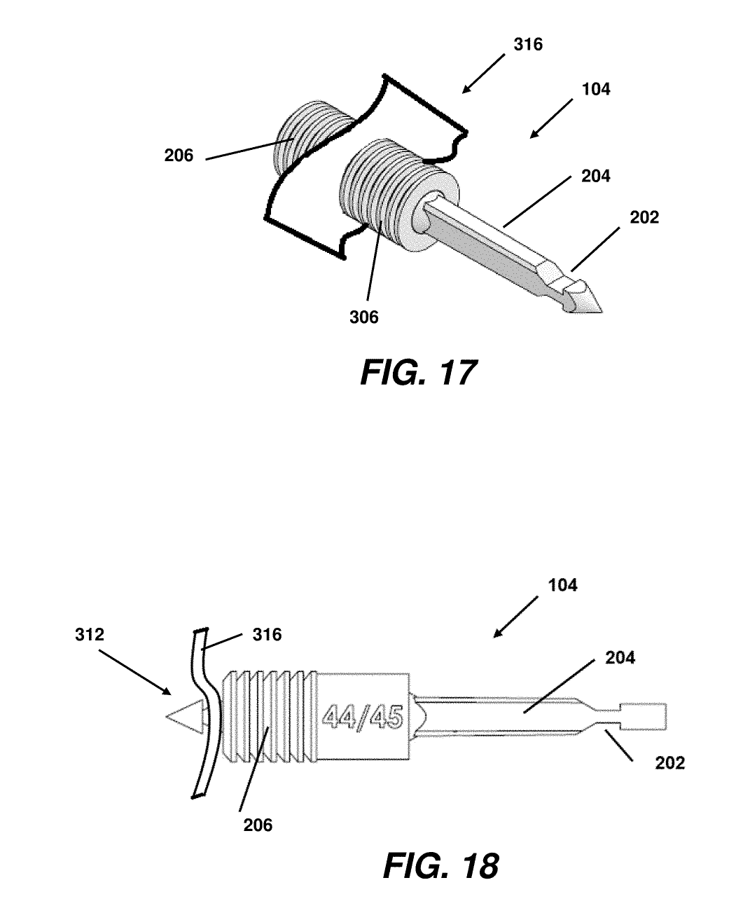

FIG. 17 illustrates the cloth 316 installed on the device of FIG. 9. As previously discussed, the cloth 316 may be sandwiched between the enlarged section 206 and the securing member 306. Similarly, FIG. 18 illustrates the cloth 316 installed on the device of FIG. 14. As previously discussed, the cloth 316 may be positioned on the notched section 312.

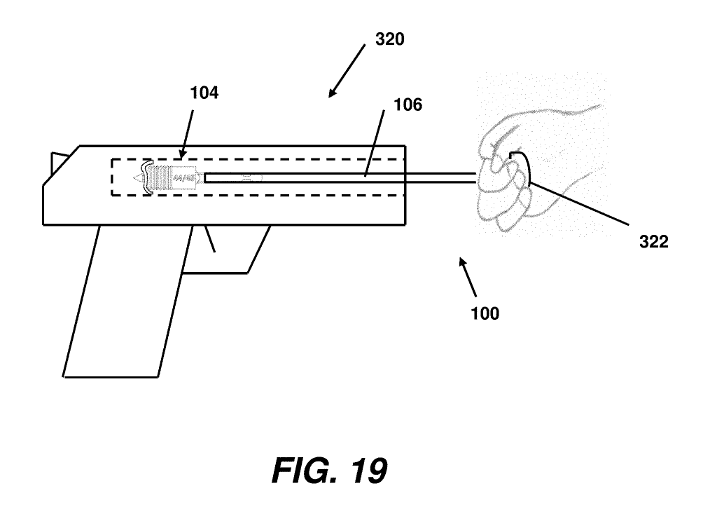

FIG. 19 illustrates an exemplary use of the cleaning tool 100 on an exemplary firearm 320. The illustrated firearm 320 is merely exemplary, any type of firearm is contemplated including, but not limited to, a handgun, shotgun, rifle, or the like. The cleaning tool 100 and its various components may be sized and configured to be used with any particular firearm 320 or any number of firearms 320. Regardless, the cleaning tool 100 may comprise a handle 322, which may be configured to be gripped by a user's hand. The cleaning rod portion 106 may be attached to the handle 322. In exemplary embodiments, the cleaning rod portion 106 may be attached to the handle 322 in a rotatable fashion.

The cloth 316 may be pre-treated or otherwise exposed to a cleaning substance or a lubricating oil, though such is not required. The cloth 316 may be attached to the cleaning device 104 as previously discussed. The cleaning device 104 may be attached to the distal end of the cleaning rod portion 106. The user may grip the handle 322 and push the cleaning device 104 axially down the barrel of the firearm 320. Similarly, the user may grip the handle 322 and pull the cleaning device 104 axially out of the barrel of the firearm 320. This process may be repeated to clean the barrel of the firearm 320. The cleaning device 104 may likewise be passed through or over other various portions of the firearm 320 for cleaning. For example, but not to server as a limitation, the cleaning tool 100 may instead be passed through the ejection port and down the barrel of the firearm 320. As another example, but again not to server as a limitation, the cleaning tool 100 may instead be passed into the interior grip chamber when the clip is removed.

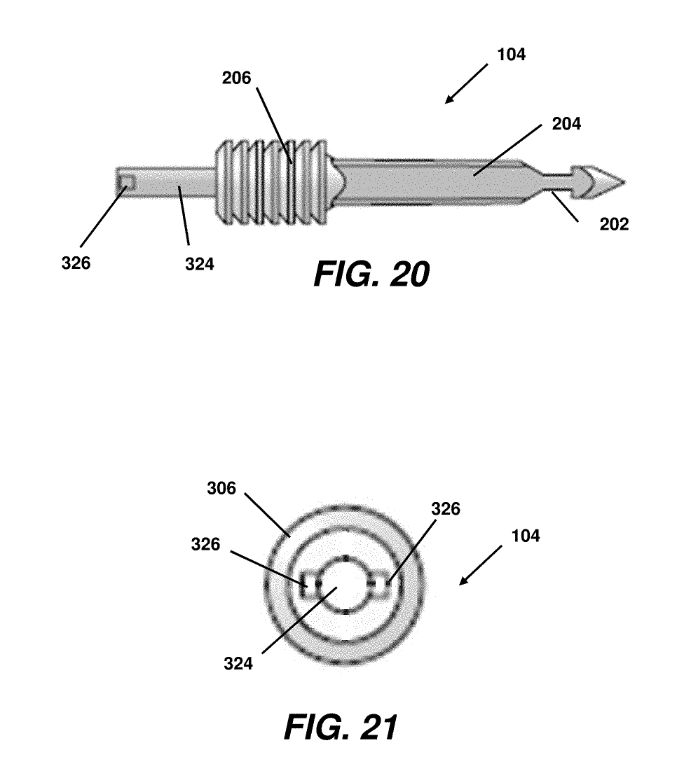

FIG. 20 through FIG. 27 illustrate another exemplary embodiment of the cleaning device 104. Similar to other embodiments presented herein, the cleaning device 104 may comprise the member 204 having the engagement groove 202 and the enlarged section 206. In exemplary embodiments, the enlarged section 206 may be substantially cylindrical in shape and comprise a ribbed outer surface, through any shape is contemplated. In exemplary embodiments the enlarged section 206 may have an outer diameter substantially equal to the inner diameter of the barrel, though any size is contemplated. In exemplary embodiments, this requires the outer diameter to be slightly smaller than the inner diameter of the barrel such that the enlarged section 206 may be moved axially through the barrel. This may result in the outer diameter substantially matching the diameter of the projectile intended to be used with the barrel assembly. Indeed, multiple size enlarged sections 206 may be provided to match various diameter barrel assemblies for various caliber projectiles.

Regardless, the cleaning device 104 may be configured to be selectively secured to the cleaning rod portion 106. In this way, the cleaning device 104 may be moved throughout the barrel for cleaning, particularly in an axial direction through a gun barrel. A handle 322 may be attached to the cleaning rod portion 106 to facilitate the axial movement by a user.

A shaft 324 may extend from the distal end of the enlarged section 206. In exemplary embodiments, the shaft 324 may have a substantially circular cross section, though any shape is contemplated. The cross section of the shaft 324 may be smaller than the member 204, though any size is contemplated. A first and second protuberance 326 may extend substantially perpendicular from the sides of the outer surface of the shaft 324. The first and second protuberances 326 may so extend near the distal end of the shaft 324, though any location along the shaft 324 is contemplated. In exemplary embodiments, the first and second protuberance 326 may extend from substantially opposite sides thereof, though any location is contemplated. It is contemplated that any number of protuberances 326 may be utilized with the present invention. The protuberances 326 may have a substantially rectangular cross section, though any shape is contemplated.

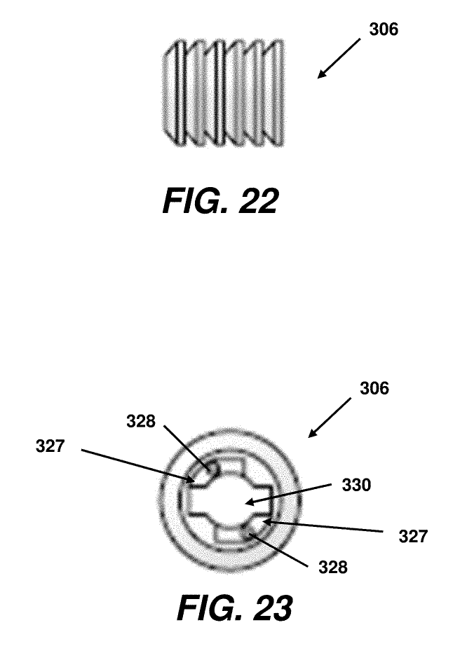

FIG. 22 and FIG. 23 illustrate an exemplary securing member 306 for use with the cleaning device of FIG. 20. The securing member 306 may comprise a securing member aperture 330 sized and configured to accommodate the shaft 324 as well as the first and second protuberances 326. In exemplary embodiments, the securing member 306 may be substantially cylindrical in shape and comprise a ribbed outer surface, through any shape is contemplated. In exemplary embodiments the securing member 306 may have an outer diameter substantially equal to, or just slightly smaller than, the inner diameter of the barrel, though any size is contemplated. In exemplary embodiments, this requires the outer diameter to be slightly smaller than the inner diameter of the barrel such that the securing member 306 may be moved axially through the barrel. This may result in the outer diameter substantially matching the diameter of the projectile intended to be used with the barrel assembly. Indeed, multiple size securing member 306 may be provided to match various diameter barrel assemblies for various caliber projectiles.

Regardless, the securing member 306 may comprise a slotted section 327 configured to accommodate the protuberances 326, which may be rotated into the slotted section 327. In exemplary embodiments, the securing member 306 may further comprise a post 328 located on or within each of the slotted sections 327. The post 328 may be located such that the posts 328 frictionally engage the protuberances 326 when the securing member 306 is rotated. In exemplary embodiments, the slotted section 327 may be located entirely within the body of the securing member 306. In other exemplary embodiments, the slotted section 327 may be located on a distal end of the securing member 306, though any location is contemplated.

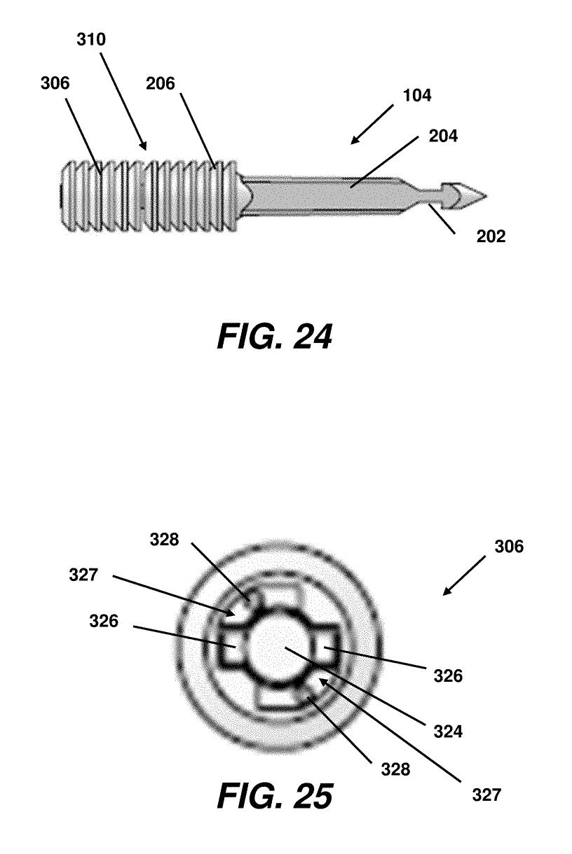

FIG. 24 and FIG. 25 illustrate the securing member 306 installed on the shaft 324 with the securing member 306 in an unlocked position. The shaft 324 may extend through the securing member aperture 330 such that the first and second protuberances 326 are aligned with the slotted sections 327.

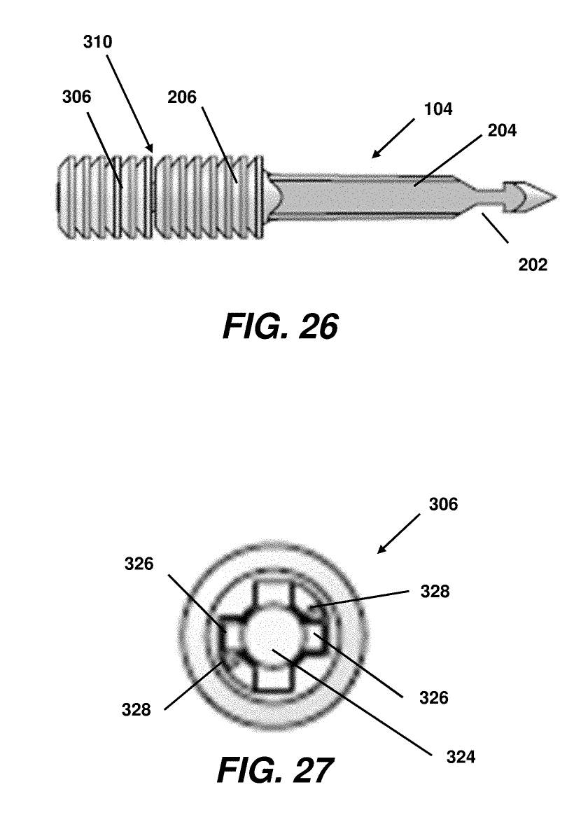

FIG. 26 and FIG. 27 illustrate the securing member 306 installed on the shaft 324 with the securing member 306 in a locked position. In exemplary embodiments, the securing member 306 may be slidably mounted to the shaft 324 by way of the securing member aperture 330. The securing member 306 may be mounted to the shaft 324 such that the slotted section 327 is aligned with the first and second protuberances 326. The securing member 306 may be rotated such that the first and second protuberances 326 are rotated into and the slotted sections 327 are substantially secured against axial movement. The securing member 306 may be rotated until the first and second protuberances 326 engage the posts 328.

The slots 327 and the protuberances 326 may be respectively located such that when the securing member 104 is mounted to the shaft 324, a gap 310 remains between the proximal end of the securing member 104 and the distal end of the enlarged section 206. The gap 310 may be configured to accommodate a cloth 316, which may be secured over the shaft 324 and within the gap 310. The cloth 316 may be sized such that when so secured it extends therefrom to facilitate contact with the barrel when moved axially therethrough.

The cloth 316 may be sized and configured to clean the barrel assembly when moved therethrough. For example, without limitation, the location of the gap 310 for the cloth 316 between the securing member 104 and the enlarged section 206 may cause the cloth 316 to be pressed against the barrel. In exemplary embodiments, when the cleaning tool 104 is inserted into the barrel assembly, the cloth 316 may be folded back against the enlarged section 206 or another component(s). The cloth 316 may then be sandwiched between the enlarged section 206, or another component(s), and the inner wall of the barrel. As the cleaning tool 104 is axially advanced into the barrel, the cloth 316 may be continually pressed against the inner diameter of the barrel to facilitate cleaning. Upon axial retraction of the cleaning tool 104, the cloth 316 may either remain pressed against said component, or may shift to be sandwiched between the securing member 306, or another component(s), and the barrel assembly. This may facilitate the use of both sides of the cloth 316. Regardless, as the cleaning tool 104 is retracted axially, the cloth 316 may remain pressed against the inner diameter of the barrel to facilitating cleaning. Additionally, the cleaning tool 104 and the attached cloth 316 may be rotated. The cloth 316 may then be removed and may be replaced as needed, for example without limitation, when said cloth 316 is worn or excessively dirtied with deposits. The process of inserting the cleaning tool 104, moving it axially along the barrel, and removing it may be repeated. In exemplary embodiments, the cleaning tool 104 may be rotated before reinsertion, though such is not required.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for cleaning debris from a tubular barrel assembly comprising:
a cleaning device comprising:
a member;
an enlarged section located on a distal end of said member, the enlarged section having an outer surface which extends beyond the outer surface of said member, and
a shaft section extending from a distal end of the enlarged section and comprising a first and second protuberance; and
a securing member comprising an aperture configured to accommodate the shaft section and the first and second protuberances, the securing member further comprising a slotted section configured to selectively engage the first and second protuberances when the securing member is rotated.

2. The system of claim 1 wherein:
the enlarged section has a substantially circular cross section and a ribbed outer surface.

3. The system of claim 2 wherein:
the securing member has a substantially circular cross section and a ribbed outer surface.

4. The system of claim 3 wherein:
the enlarged section and the securing member have substantially the same diameter; and
the outer diameter of the enlarged section and the securing member are substantially the same as the inner diameter of the tubular barrel assembly.

5. The system of claim 1 wherein:
the first and second protuberances are located such that a gap is formed between the proximal end of the securing member and the distal end of the enlarged section when the first and second protuberances are rotated into the slotted section;
said gap is sized to accommodate a cloth.

6. The system of claim 1 wherein:
the shaft section has a substantially circular cross section; and
the first and second protuberances extend substantially in line with one another from substantially opposite sides of the shaft section.

7. The system of claim 1 wherein:
said member is configured to be selectively mated with a barrel cleaning tool comprising a cleaning rod portion.

8. The system of claim 7 further comprising:
an engagement groove located on a proximal end of said member, wherein said engagement groove is configured to selectively frictionally engage a latch device located on said cleaning rod portion of said barrel cleaning tool.

9. The system of claim 8 wherein:
said barrel cleaning tool further comprises:
a rectangular recess formed in one end of the cleaning rod, the recess tapering from the end of the cleaning rod to the end of the recess, and
an opening formed in the outer surface of the cleaning rod portion where the opening is in communication with the recess and tapered to align with the inner walls of the recess,
wherein the latch device is located within the opening where a leading end of the latch device has a protrusion extending inwardly toward the recess, the protrusion configured with an angle of less than 90 degrees from a face of the protrusion to the surface of the latch device,
wherein the barrel cleaning device comprises an elongated rectangular and tapered shaft that is sized such that it is configured to be inserted into the recess.

10. The system of claim 9 wherein:
said barrel cleaning tool further comprises a receiving recess portion located on the shaft with a wall having a surface angle corresponding to that of the protrusion of the latch device, the wall configured to engage the protrusion of the latch device when the shaft is inserted into the rectangular recess of the cleaning rod.

11. The system of claim 1 wherein:
the slotted section comprises a first and second slot, wherein each of the first and second slots extend in an arc that is substantially concentric with the aperture.

12. The system of claim 11 further comprising:
a first and second post, wherein the first and second post are located within the first and second slots, respectively, and wherein said posts are configured to frictionally engage said first and second protuberances when said securing member is rotated.

13. A system for cleaning debris from a tubular barrel assembly comprising:
a cleaning device comprising:
a member comprising an engagement groove located on or near a proximal end thereof,
an enlarged section comprising a substantially circular cross section and a ribbed outer surface, said enlarged section extending from a distal end of the member, and
a second member extending from a distal end of the enlarged section and comprising a first and second protuberance; and
a securing member comprising a substantially circular cross section and a ribbed outer surface, said securing member configured to be slidably mounted to said second member, said securing member further comprising an aperture configured to accommodate the second member and the first and second protuberances, the securing member further comprising a first and second slot configured to selectively engage the first and second protuberances when the securing member is rotated;
wherein the first and second protuberances are located such that a gap sized to accommodate a cloth is formed between the proximal end of the securing member and the distal end of the enlarged section when the first and second protuberances are rotated to engage the first and second slots.

14. The system of claim 13 wherein:
the outer surface of the enlarged section extends beyond the outer surface of the member and the second member.

15. The system of claim 14 wherein:
the second member is substantially cylindrical in shape;
the securing member is substantially cylindrical in shape; and
the first and second protuberances extend substantially in line with one another from substantially opposite sides of the shaft section.

16. The system of claim 15 wherein:
the first and second slots form arc shaped paths that are substantially concentric with the aperture; and
the first and second slots are formed within the securing member.

17. The system of claim 16 further comprising:
a first post and a second post, wherein the first and second posts are located within the first and second slots, respectively, and wherein said posts are configured to frictionally engage said first and second protuberances.

18. The system of claim 15 wherein:
the first and second slots form arc shaped paths that are substantially concentric with the aperture; and
the first and second slots are located on a distal end of the securing member.

19. The system of claim 13 further comprising:
a cleaning rod having a latch device located on or near a first end thereof, wherein the latch device is configured to be selectively secured within the engagement groove such that the cleaning rod is secured to the cleaning device; and
a handle extending from a second end of the cleaning rod.

20. A system for cleaning debris from a tubular barrel assembly comprising:
a cleaning device comprising:
a member comprising an engagement groove,
an enlarged section having a substantially cylindrical shape and comprising a ribbed outer surface, said enlarged section extending from a distal end of the member, and
a second member extending from a distal end of the enlarged section and comprising a first and second protuberance; and
a securing member having a substantially cylindrical cross shape and a ribbed outer surface, said securing member configured to be slidably mounted to said second member, said securing member further comprising an aperture configured to accommodate the second member, the first protuberance, and the second protuberance, the securing member further comprising a first and second slot forming arc shaped paths that are substantially concentric with the aperture, said slots being configured to selectively engage the first and second protuberances when the securing member is rotated;
a cleaning rod having a latch device located on or near a first end thereof, wherein the latch device is configured to be selectively to the engagement groove such that the cleaning rod is secured to the cleaning device;
a handle extending from a second end of the cleaning rod; and
a gap defined by the space between the securing member and the enlarged section when the first and second protuberances are located within the first and second slots;
wherein the enlarged section and the securing member have outer diameters that are substantially the same as the inner diameter of the tubular barrel assembly.
